(19) United States
(12) Patent Application Publication
(10) Pub. No.: US 2014/0185609 A1
(43) Pub. Date: Jul. 3, 2014

(54) SYSTEMS AND METHODS FOR PROVIDING INFORMATION IN A CONTACT LIST

(71) Applicant: VONAGE NETWORK, LLC, (US)

(72) Inventors: Tzahi Efrati, Givataim (IL); Ido Mintz, Burgata, IL (US)

(73) Assignee: VONAGE NETWORK, LLC, HOLMDEL, NJ (US)

(21) Appl. No.: 13/730,380

(22) Filed: Dec. 28, 2012

(51) Int. Cl. H04M 1/274

(52) U.S. Cl. CPC H04M 1/274
USPC 370/352

(57) ABSTRACT

Systems and method are provided for deriving contact information for one or more contacts of a contact list. This information is used to modify how contacts on the contact list are displayed. The modification can include changing an order in which the contacts are presented on a contact list.

### FIELD OF THE TECHNOLOGY

The technology is related to voice over Internet protocol (VOIP) telephony systems, and more specifically, to systems and methods for providing and updating information for contacts in a contact list.

### BACKGROUND OF THE TECHNOLOGY

The telecommunications environment has vastly expanded over the last two decades. It was not long ago when the average telephone user had to answer phone calls to take messages where voicemail now handles such tasks. Likewise, telephone users were limited in their options for managing phone lists for their friends, family, and/or co-workers.

Current telephony devices now include memory capacities that users would not have envisioned two decades ago. “Smartphones” have processing power that rivals present personal computer technology. Similarly, these telephony devices have high resolution displays that are now capable of playing high resolution video. Thus, today's telephony devices are more robust in the amount of information they can store, process, and display.

Telephony devices have had the ability to manage phone lists for users in what is commonly referred to as a contact list. The information that can be stored and utilized in the contact list ranges from the very basic (e.g., name and phone number) to the relatively more comprehensive (e.g., email address, picture, social networking accounts, etc.).

Many “smartphones” today are capable of linking phone contacts for a user with other accounts associated with the user. For example, the user may have a Facebook® account, a Linkedin® account, and a Gmail® email account. Present telephone technology allows the contact list for this user to “link” information between each account. Then, by selecting a specific contact, this “linked” information will be compiled into the single contact for the user's reference.

One drawback to present contact lists is that the lists still only provide relatively simplistic information when viewing the contacts in a “list mode.” In most phones, the contacts will be shown with their name, telephone number, and maybe an associated thumbnail image of the contact. Furthermore, the “linked” information may provide little more than an indication of which accounts the particular contact is associated with. Likewise, there is little derived from the “linked” information that can provide the user with useful information for a particular contact (e.g., the time of day in the time zone where the contact is located, the weather where the contact is located).

Thus, there is a need to provide a system that can derive peripheral information for one or more contacts based on a one or more details for a contact (e.g., the location of a contact), and update the display of the contacts based on the peripheral information. There is also a need to prioritize (or re-order) contacts based on derived peripheral information.

### BRIEF DESCRIPTION OF THE FIGURES

FIG. 1 is a diagram of a communications environment that includes an IP telephony system capable of obtaining information regarding contacts and of using that information to determine how to modify the display of the contacts in contact lists;

FIG. 2 is a schematic diagram of a controller that may be used to practice one or more embodiments of the present technology;

FIG. 3 is a diagram illustrating steps of a method for generating and providing information related to the display of one or more contacts in a contact list;

FIG. 4 is a diagram illustrating steps of a method for displaying one or more contacts in a contact list using obtained information regarding the contacts;

FIG. 5 is a diagram illustrating steps of a method performed by an IP telephony system for determining how to alter the order of one or more contacts in a contact list; and

FIG. 6 is a diagram illustrating steps of a method performed by an application on a telephony device for ordering one or more contacts in a contact list.

### DETAILED DESCRIPTION OF PREFERRED EMBODIMENTS

In the following description, references are made to a telephony device. The term “telephony device” or “communication device” is intended to encompass any type of device capable of acting as a telephony device. This includes a traditional analog telephone, an IP telephone, a computer running IP telephony software, cellular telephones, mobile telephony devices such as smartphones that can connect to a data network and run software applications, such as the Apple iPhone™, mobile telephony devices running the Android™ operating system, Blackberry™ mobile telephones, and mobile telephones running the Symbian® operating system.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch can interact with an IP telephony system to conduct a telephone call.

The present technology relates to enhancing the display and ordering of contact information in a contact list. The display and ordering of contact information can be implemented within a variety of systems and devices. In the processes described below, the display and ordering of the contact information can, for example, be implemented at an IP telephony system responsible for managing contact information for one or more users. The implementation can also be performed using a software application on one or more communication devices where the communication devices will modify the display and/or order of contact information.

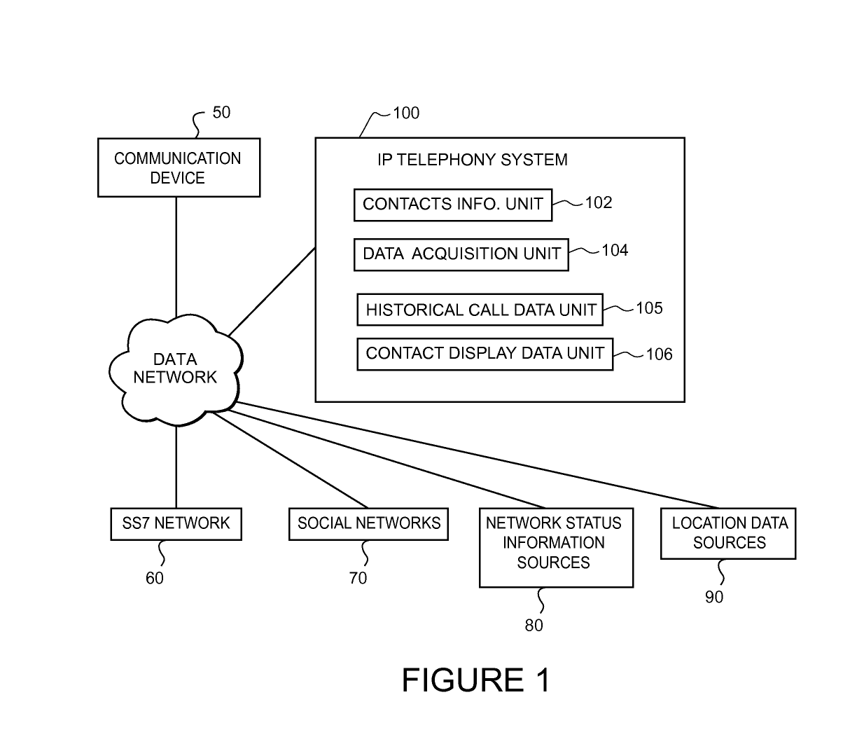

FIG. 1 shows a communication environment where information is collected from one or more different sources so that contact information in a contact list can be modified accordingly. The IP telephony system 100 in FIG. 1 is configured to communicate develop information that is used to modify the display of contact in contact lists. This contact display information is sent to a communications device 50 via a data network 120. The communication device then alters how contacts on a contact list are displayed to a user.

The data network 120 could be a public data network such as the Internet, or a private data network. Also, the data network 120 illustrated in FIG. 1 could be comprises of both private data networks and public data networks.

Although only one communication device 50 is shown in FIG. 1, it should be appreciated that the IP telephony system 100 can communicate with multiple communication devices 50. It should also be appreciated that each communication device 50 may have more than one contact list stored in the device 50. Likewise, the IP telephony system 100 can manage multiple contact lists for one or more communication devices 50.

As an example, the communications device 50 can be a “smartphone” that stores one or more contact lists using a memory in the communications device 50. The communications device 50 may synchronize the contact list with the IP telephony system 100. The IP telephony system 100 can store and/or manage contact lists and information about contacts in a contacts unit 102. The IP telephony system 100 can retrieve and maintain information regarding one or more contacts with a data acquisition unit 104, as will be described in detail below.

The IP telephony system includes a contacts information unit 102 which stores contacts, contact lists, and information about the contacts. A data acquisition unit 104 obtains information regarding contacts, and that information can be stored in the contact information unit 102, or simply used temporarily to develop display data for the contacts. A historical call data unit 105 of the IP telephony system 100 stores information about who individual contacts have communicated with in the past. This can include information about outgoing calls placed by a contact, as well as information about incoming calls received by a contact. This could also include information about other forms of communication that have been sent by or received by a contact, such as text message.

A contact display unit 106 of the IP telephony system 100 uses information regarding contacts that is obtained by the data acquisition unit 104, from a communication device 50, from the historical call data unit 105, and from other sources to determine whether and how to modify how a contact is displayed on a contact list. The ways in which the display of contacts can be modified, and the reasons for doing so, are discussed in detail below.

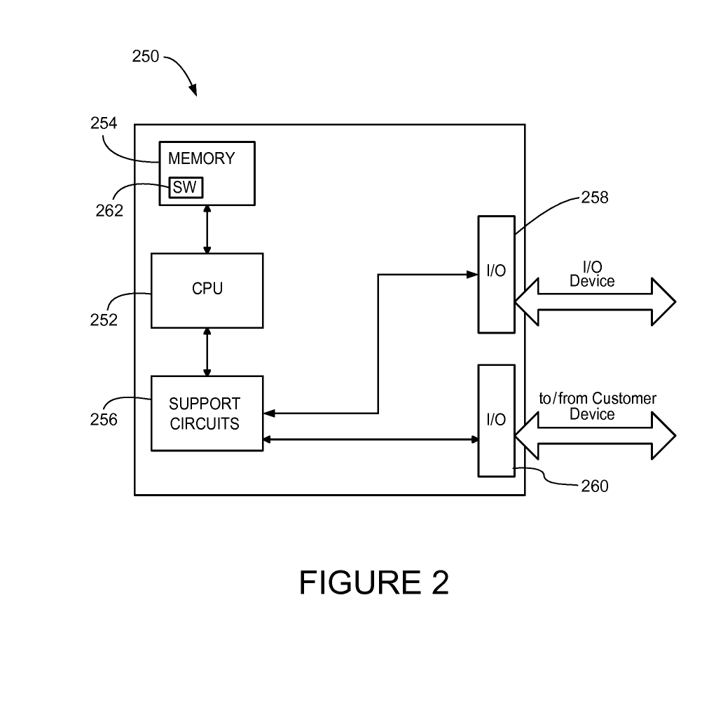

FIG. 2 illustrates elements of a computer processor 250 that can be incorporated in elements of the IP telephony system 100 to accomplish various functions. The IP telephony system 100 could utilize multiple processors 250 located at various locations, along with their own operating components and programming, each carrying out a specific or dedicated portion of the functions performed by the IP telephony system 100.

The processor 250 shown in FIG. 2 may be one of any form of a general purpose computer processor used in operating an IP based communication system. The processor 250 comprises a central processing unit (CPU) 252, a memory 254, and support circuits 256 for the CPU 252. The processor 250 also includes provisions 258/260 for connecting the processor 250 to customer equipment via one or more access point and a data channel provided by a cellular service provider, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

Another form of processor 250 that assists in execution and is otherwise part of the subject invention is found within one or more of the mobile telephony devices. Such devices are sufficiently advanced beyond early generation cellular telephones that they contain processors capable of running operating systems developed by device manufactures, as well as third party applications that are downloaded and installed by users to performing a myriad of communications and non-communications oriented tasks.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 100. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

Returning now to a discussion of the elements of the IP telephony system 100, the data acquisition unit 104 is configured to obtain information regarding contacts from one or more information sources. The information sources can include servers and information gateways accessible over the data network 120.

For example, the data acquisition unit 104 may obtain information about communication or telephony devices from an SS7 network. Signaling that is conducted over the public switched telephone network (PSTN), which for purposes of this description includes both landline type telephony systems and cellular telephony systems, can be executed by processors, servers and gateways that operate according to Signalling System No. 7 (SS7) protocols. SS7 is a set of telephony signaling protocols which are used to set up public switched telephone network telephone calls. The main purpose is to set up and tear down telephone calls. Other uses include number translation, local number portability, prepaid billing mechanisms, short message service (SMS), and a variety of other mass market services.

The SS7 network 60 can provide information regarding the location of a telephony device. For example, the data acquisition unit 104 could send a query to the SS7 network 60 that provides the phone number for a contact, and that requests the location of the telephony device assigned that phone number. The telephony device could be a landline telephone, or a cellular telephone. The SS7 network 60 would determine information regarding the present location of the telephony device assigned that telephone number, and forward the location information back to the data acquisition unit 104 of the IP telephony system 100. Although the telephone number of a contact could be used to query the SS7 network 60, other identifying information may also be used, such as the contact's name, some other unique identifier associated with the contact, or a unique identifier associated with a telephony device.

In addition to location information, the SS7 network 60 may also be capable of providing other items of information about contacts. For example, the SS7 network 60 may be able to provide information about a contact's telephony device, such as its capabilities, whether the telephony device is presently roaming, whether the telephony device is presently available to conduct a communication, the type of communication plan associated with the telephony device, as well as other information. This type of information could also be obtained by the data acquisition unit 104.

The data acquisition unit 104 is also able to obtain information regarding a contact from social networks 70. For example, a contact may have a Facebook® account, and a variety of items of information for the contact may be present within Facebook®. This information could include, but is not limited to, a home address, place of employment, date of birth, anniversary dates, current address, current location, etc. The data acquisition unit 104 can obtain such information from a social network 70 and utilize and store the information in the contacts unit 102. This contact information can then be conveyed to a communication device 50 and also used to determine how to display a contact in a contact list.

A social network 70 is also capable of providing various other items of information. For example, a social network 70 can provide information related to the contact's friends/connections listed on the social network 70. That is, John Smith may have various “connections” in his social network account and this information may be obtained by the data acquisition unit 104. A social network 70 may also provide information related to various events for a contact. A social network 70 may also be capable of providing information about the location of a contact. For example, the social network 70 may indicate that a contact has “checked-in” at a specific location. Of course, the social networks 70 are not limited to providing the information listed above. They could also provide a great many other items of information to the IP telephony system 100.

In some instances, such as where a contact is a member of a social network 70, and also a customer of the IP telephony system 100, the contact may have provided the IP telephony system 100 with permission to obtain information from the contact's account with the social network 70. The contact may have also provided the IP telephony system 100 with the contact's credentials on the social network 70, in the form of a user name and password, so that the IP telephony system 100 can log into the social network 70 to review and retrieve information from the contact's account on the social network 70. In some instances, the IP telephony system 100 may have received authorization from a user to access certain information on a social networking system, and the IP telephony system 100 may be able to access this information without actually logging into the social networking system with the user's name and password.

In other instances, the IP telephony system 120 may be capable of retrieving information about a first person from a social network 70, even though the first person is not a customer of the IP telephony system 100, and has not provided the IP telephony system 100 with his social network credentials. For example, the IP telephony system 100 may have obtained the credentials for a second person who is also a member of the social network 70, such that the IP telephony system 100 can log into the social network 70 using the second person's credentials. If the first person is connected with the second person on the social network 70, the second person will likely have access to certain information about the first person that is stored on the social network 70. Thus, the IP telephony system 100 may be able to obtain information about a first person on a social network 70, by logging into the social network 70 using the credentials of a second person.

The data acquisition unit 104 can also communicate with network status information sources 80 to obtain network status information for a contact's telephony device. The network status information sources 80 can be a single device, server or gateway that determines the network status of one or more telephony devices for one or more contacts. Alternatively, the network status information sources 80 can also be comprise multiple devices which are in contact with multiple telephony devices.

One example would be where a contact uses a smartphone that runs an IP telephony software client provided by an IP telephony system. Each time that the smartphone is able to establish a data connection to the IP telephony system, the software client registers with the IP telephony system. The registration message received by the IP telephony system would have an originating IP address for the wireless access point that the smartphone uses to access the data network. Various items of information regarding the contact's smartphone would be available once the software client on the smartphone has registered with the IP telephony system. That information could be made available to the data acquisition unit 104 by the network status information sources 80.

For example, the IP telephony system with which the smartphone registers can indicate whether the smartphone is presently connected to the data network via a wireless access point, and thus whether the contact's smartphone is available to receive communications over the IP telephony system. The IP telephony system could also report the IP address of the wireless access point being used by the contact's smartphone. This information could then be used to determine the approximate present location of the smartphone.

The network status information sources 80 may also provide information as to whom a contact has called and/or who the contact has received calls from, as well as the timing, frequency and duration of those calls. However, this same type of information may also be available in the historical call data unit 105 of the IP telephony system 100.

As mentioned above, the data acquisition unit 104 could obtain information about the present location of a contact, or a contact's telephony device from multiple different sources. Once the contact's location is known, the data acquisition unit 104 could consult location data sources 90 to obtain information relevant to that location. For example, a location data source 90 can provide information related to a current weather forecast for a contact's present location. This information, in turn, can be used to modify how a contact is displayed on a contact list.

For example, if the data acquisition unit 104 determines that a contact is located in Arlington, Va., the data acquisition unit could then consult a location data source 90 to determine that the current weather in Arlington, Va. is 45 degrees Fahrenheit and cloudy. This weather information can be incorporated into the display of the contact's information on a contact list. For example, the contact list could include the symbol “45°,” and a background of clouds can be displayed for the contact in a contact list. Likewise, if there is a weather alert for Arlington, Va. the display item for the contact can indicate the weather alert (e.g., by flashing the contact in red, using a “lightning” animation over the contact, etc.) in the contact list.

In some instances, the data acquisition unit 104 may be able to gather information about a projected future location of a contact. The projected future location could be determined by accessing a travel itinerary or schedule for the contact.

The data acquisition unit 104 can obtain many other items of location-specific information from the location data sources 90. For example, the data acquisition unit 104 could obtain the time of day at a contact's location. Time-of-day information could be used to alter how a contact is displayed by a communication device. For example, if the current time-of-day at a contact's location is 11 PM, the display of the contact may be shaded a darker color to indicate that it is nighttime at the contact's location. Alternatively, a symbol indicative of the time-of-day could be displayed adjacent the contact, such as a moon symbol to indicate that it is nighttime at the contact's location.

The data acquisition unit 104 could retrieve local news items that are relevant to a contact's location. Local news related to a contact's location may also trigger a change in the display of the contact. For example, if a local sports team where a contact is located wins their division, the contact's information could be modified to show a “celebration” theme indicating that the location is celebrating the win. Of course, the local news could be any particular news worthy event triggering a modification of how a contact's information is presented.

The way in which the display of a contact is altered could take many different forms. When a contact list is displayed by a communication device 50, particular contacts could be highlighted in various ways to indicate various things. This could include changing a background shading or color upon which a contact appears, and altering the text or font used to display a contact. A contact might flash or move in some fashion to indicate some relevant fact. Also, various icons or graphical symbols may be displayed over or adjacent to a contact. Virtually any type of modification to the standard display could be used to indicate some item of information that is relevant to individual contacts.

In addition to modifying how a contact is presented in a contact list, one could also alter the order in which the contacts are presented based on the information obtained by the data acquisition unit 104. For example, if a dangerous weather alert has been issued for a particular contact's location, the contact could be moved to the top of the contact list. The way in which the contact is displayed might also be altered to highlight the fact that a dangerous weather alert has been issued for that contact's location.

In another example, all contacts which have a birthday or important anniversary might be moved to the top of a contact list. Any information which has been determined for a contact could be used to modify the order in which the contacts are presented on a contact list.

In the above-discussed examples, information that is obtained for a contact is used to modify the way in which a contact is displayed on a contact list, or the order in which contacts in a list are presented. The information that is obtained for a contact could also include information about a contact's call history. For example if the user of the communication device 50 typically places a call to a particular contact at approximately 5:00 pm every afternoon, and the present time is 4:55 pm, then when the user requests the display of a contact list on the communication device 50, the communication device could place that contact at the top of the contact list, anticipating that the user is likely to be placing a call to that contact. Thus, the modification of a contact list may be time-of-day dependent, or day-of-the-week dependent. In other words, the order in which contacts are displayed may change depending on the time of day or the day of the week.

In another example, if the user of the communication device places the vast majority to all outgoing calls to the same ten contacts, then the communication device 50 may place those ten contacts at the top of a displayed contact list. Further, the order of those ten contacts may be based on the frequency with which the user places calls to those ten contacts.

Information about incoming calls received by the user may also be used to modify the order in which contacts are presented on a contact list.

The SS7 network 60, the social networks 70, the network status information sources 80 and the location data sources 90 could take many different forms. In some instances, the data acquisition unit 104 could consult a single server or gateway dedicated to providing a certain type of information. That dedicated server could in turn query multiple other data sources to obtain the data requested by the data acquisition unit 104. Alternatively, the data acquisition unit 104 could consult multiple different servers, all of which together comprise the location data sources 90 or the social networks 70.

In some embodiments, one or more of the network status information sources 80 and the location data sources 90 may be a part of the IP telephony system 100. In other embodiments, these elements could be completely independent of the IP telephony system 100.

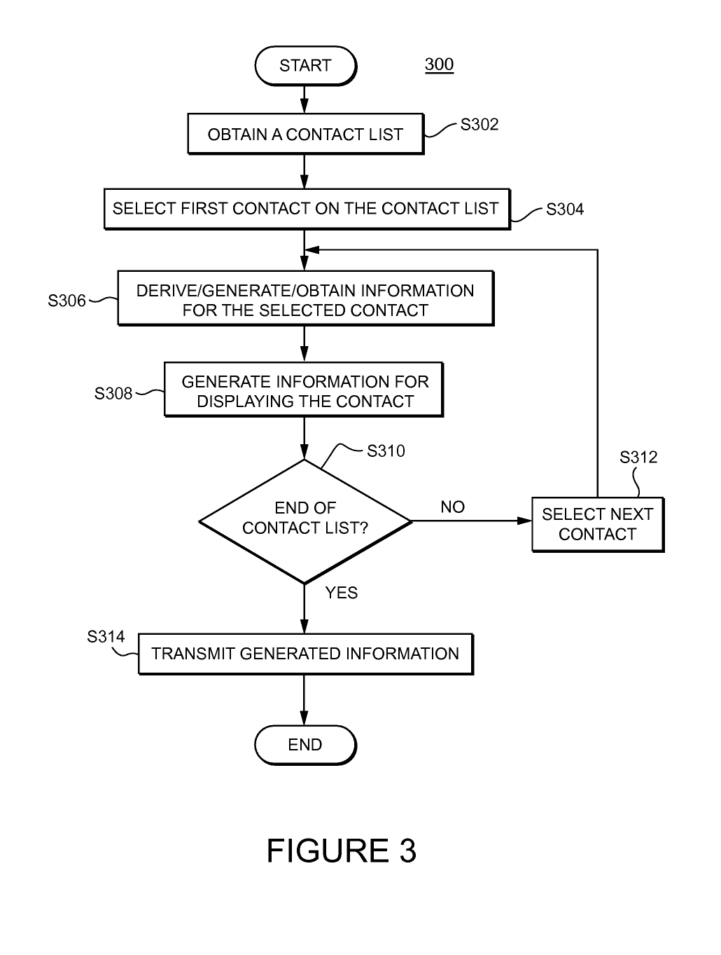

FIG. 3 is a diagram illustrating steps of a method 300 for obtaining and/or generating information related to one or more contacts in a contact list, and then using that information to instruct a telephony device about how to alter a display of the contacts in a contact list. The method 300 illustrated in FIG. 3 would be performed by elements of an IP telephony system 100 multiple times, one time for each contact list.

The method begins and proceeds to step S302, where the IP telephony system 100 obtains a contact list. The contact list could be obtained from a communication device 50. In one example, the device 50 can communicate the list to the IP telephony system 100. Alternatively, the IP telephony system 100 can store and manage the contact list for the device 50.

In step S304, the IP telephony system selects the first contact on the list. In step S306, the IP telephony system obtains, derives or generates information for the first selected contact. As discussed above, a data acquisition unit 104 of the IP telephony system 100 can obtain/derive location information for the contact or a telephony device used by the contact from various sources, such as the SS7 network 60, one or more social networks 70 or a network status information source 80. Once the present location of the contact is determined, the data acquisition unit 104 can derive/generate/obtain additional information for the contact using one or more location data sources 90. For example, the IP telephony system 100 can use the location information to query a location data source 90 to determine a current weather forecast, local news, and/or a time-of-day at the particular location. In addition, call data for the contact may be obtained from a historical call data unit 105 of the IP telephony system, or from a network status information source 80.

After obtaining or developing information for the contact, in step S308 a contact display data unit 106 of the IP telephony system 100 generates information for displaying the contact in a contact list. For example, the derived information may indicate that a current time-of-day for a contact is 2 PM, the current weather at the contact's location is sunny and 70 degrees, and that it is the contact's birthday. In this case, the contact display data unit 106 generates information in step S308 that is used to instruct a communication device 50 to change the display of the contact such that the contact appears with a “sunny,” lighter colored background with festive decorations surrounding the contact name indicating that a special event is occurring related to the contact.

In step S310 a check is performed to determine if the contact just processed is the last contact on the list. If not, the method proceeds to step S312, wherein the next contact on the list is selected. The method then loops back to step S306. This process repeats until the check performed in step S310 indicates that the last contact on the list has been processed. At that point, the method proceeds to step S314 where the IP telephony system 100 transmits the contact display information generated while performing step S308 to a communication device 50.

In some embodiments, not all contacts on a contact list may be processed as described above. Instead, once a contact list is obtained in step 302, a sub-group of the contacts on the list is determined. The sub-group could include, for example, only those contacts on the list that regularly communicate with the user from which or for which the contact list was obtained. Other criteria could be used to establish a sub-group. For example, one sub-group could be for social friends and another sub-group could be for business contacts. Also, a user may designate certain contacts to include them in a sub-group.

Once the sub-group is identified, information is only obtained and generated in steps S306 and S308 for the contacts in the sub-group. Operating in this fashion could greatly speed to the process, because it would be unnecessary to obtain and process information for contacts on the list who never or only rarely communication with the user.

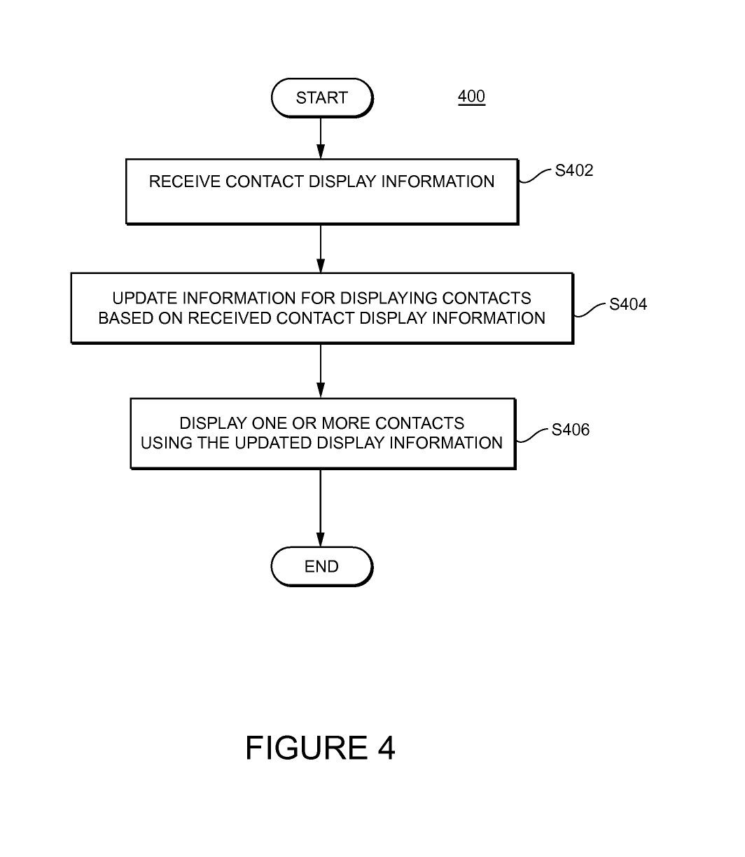

FIG. 4 is a diagram illustrating steps of a method 400 that would be performed by a software application on a communication device 50 that displays one or more contact lists. The method begins and proceeds to step S402, where the software application on the communication device 50 receives contact display information about how to display contacts in a contact list. This information would be sent to the communication device 50 from the IP telephony system 100. In some embodiments, the information received from the IP telephony system 100 would contain multiple data records, each record corresponding to a contact in a contact list. In each data record, information that can be used to alter the display of a contact is provided.

In step S404, the software application on the communication device 50 updates information for displaying one or more contacts in a contact list based on the information received from the IP telephony system 100. In step S406, the software application then causes the communication device 50 to display the one or more contacts using the updated display information.

It should be appreciated that the contact information is not limited to examples given above. For example, the contact information could include status information indicative of a speed of movement of a contact (e.g., if a contact is in a moving vehicle), whether a contact is “idle” and for how long, the last time a contact made a call, and/or whether the contact is on another call. Any number of different items of information about a contact could be indicated in the display of the contact on a contact list.

The user of a communication device 50 may specify in the settings of the software application the types of information or status indicators that are to be displayed in the contact list. Also, the contacts themselves may be capable of instructing the IP telephony system 100 about what items of information the IP telephony system 100 can pass along to communication devices 50 for display on a contact list. Thus, the contacts themselves may have some control over what information is presented about them in a contact list on another person's communications device.

Contacts may also be capable of setting up certain messages that are to be displayed on the contact lists of others (e.g., “I'm away”). The messages may be displayed automatically, based on other statuses (e.g., if on the phone, “on another call” is displayed).

In some embodiments, the software application on a communication device may provide on-demand status information about particular contacts. For example, if the user of the communication device requests the status of a contact, the software application on the communication device 50 could query the IP telephony system 100 for this information. The IP telephony system 100 would then perform a process such as the one illustrated in FIG. 3 to obtain information about the contact, and to provide that information back to the requesting communication device 50. The communication device would then use the received information to alter how the contact is displayed on a contact list.

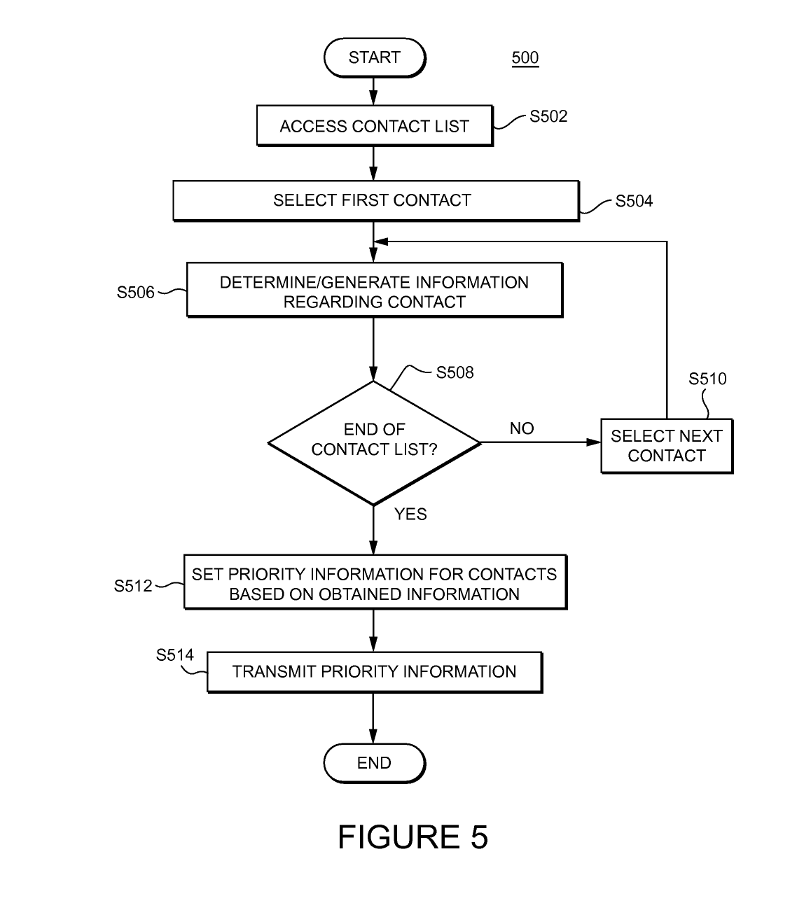

As mentioned above, in addition to altering how a contact is displayed in a contact list, it is also possible to alter the order in which contacts are displayed based on various items of information that are obtained regarding the contacts. FIG. 5 is a diagram illustrating steps of a method 500 that would be performed by an IP telephony system to obtain information about contacts on a contact list, to determine priority order information for the contacts, and to send that priority order information to a communication device.

The method begins and proceeds to step S502, wherein the IP telephony system 100 accesses or obtains a contact list. Upon obtaining the contact list, in step S504 the IP telephony system 100 selects the first contact in the list. In step S506, the data acquisition unit 104 of the IP telephony system 100 obtains and or generates information about the selected contact. The way in which the data acquisition unit obtains/determines/generates information about a contact, and the items of information that are collected, are similar to those described above with respect to the method illustrated in FIG. 3.

In step S508, a check is performed to determine if the last contact on the list has been processed. If not, the method proceeds to step S510, and the next contact on the list is selected. The method then returns to step S506, so that information regarding the newly selected contact is obtained. The process repeats until a check performed in step S508 indicates that all contacts in the list have been processed.

In step S512, the contact display data unit 106 uses the information obtained to set priority information for the contacts. The priority information would indicate the order in which contacts on a contact list should be displayed. For example, if one or more contacts have weather alerts associated with the locations of the respective contacts, the priority information set in step S512 will be designed to cause a communication device 50 to display a contact list such that contacts with weather alerts are displayed out-of-order, on the top of the contact list. The remaining contacts on the list could then appear in alphabetical order, for example. In step S514, the priority information developed in step S512 is transmitted to a communications device 50.

The priority order for contacts could be based on information that was gathered for a contact during a present cycle, and also based on information gathered during previous information gathering cycles. Thus, the fact that no new information was gathered for a contact during a present cycle does not mean that the contact will fall back into the regular alphabetical listing. A contact could remain high in the order for a certain period of time after information is gathered for the contact.

As noted above, the information obtained about the contacts could include information about a contact's calling patterns or calling history. This information could be used alone, or with other information in step S512 to determine the priority order in which contacts should be displayed on a list.

The discussion above with respect to the methods illustrated in FIGS. 3 and 5 involved either developing information to alter how a contact is displayed (the method in FIG. 3) or developing information to modify the order in which contacts are displayed (the method in FIG. 5). In alternate embodiments, information about how a contact is to be displayed, and information regarding the order in which the contacts are to be displayed could be developed at the same time during performance of a single method. The display information would then be provided to a communications device 50 so that the communications device can both alter how individual contacts are displayed, as well as modify the order in which they are displayed.

In some embodiments, a software application on a communication device 50 receives the priority information developed by an IP telephony system 100 as described above, and simply causes the contacts in the contact list to be displayed in the specified order. In other embodiments, the software application on a communication device 50 can receive information about contacts on a contact list, and determine the priority order itself, locally.

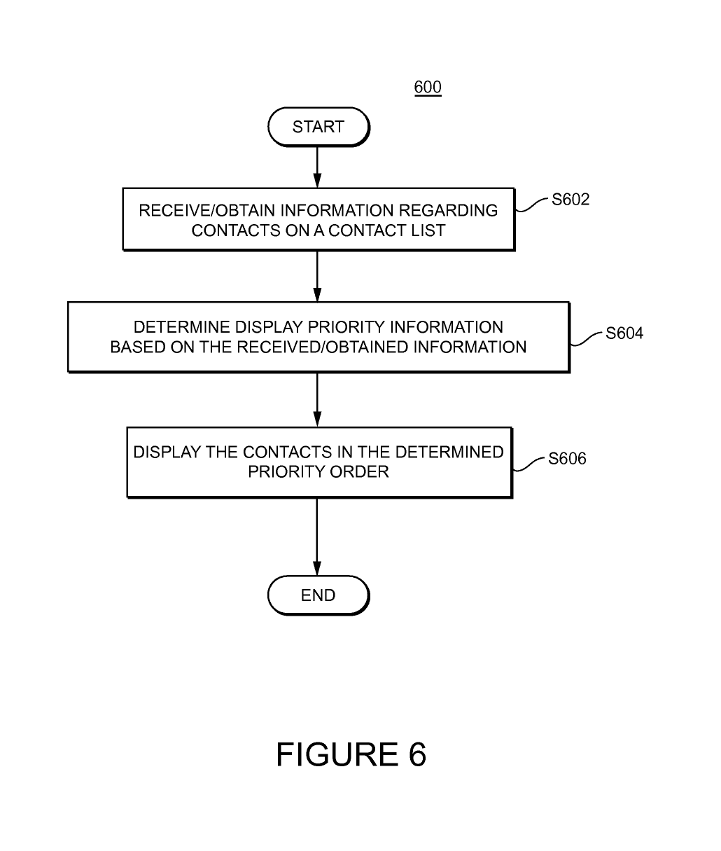

FIG. 6 is a diagram illustrating steps of a method 600 that would be performed by an application on a communication device 50 to determine the order in which one or more contacts in a contact list should be displayed.

The method begins and proceeds to step S602, where the software application on the communication device 50 receives and/or obtains information regarding one or more contacts in a contact list. The information regarding the contacts can be received from an IP telephony system 100. Alternatively, the software application could obtain information about the contacts from other sources. For example, the software application could perform methods such as the one described above in connection with FIG. 5 to obtain information about contacts from various sources.

In step S604, the obtained information is used to determine the display order for the contacts in the contact list. In step S606, the contacts in the list are displayed in the determined priority order.

As noted above, the ordering/prioritizing of contacts may change based not only on information obtained about the contacts, but also based on information that is available to the communication device itself. For example, the communication device may know the frequency and timing of calls placed to/or received from a particular contact. This information may also be used in step S604 to set the display order.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of determining display information related to one or more contacts in a contact list, comprising:
determining contact information for one or more contacts in at least one contact list; and
generating display information related to the display of the one or more contacts based on the determined contact information.

2. The method of claim 1, wherein the contact information is determined based on information provided from one or more communication devices that are operating under the Signalling System No. 7 protocol.

3. The method of claim 2, wherein the contact information is location-based information related to a location of a contact.

4. The method of claim 1, wherein the contact information is determined using a telephone number associated with the one or more contacts.

5. The method of claim 1, wherein the contact information for a contact is determined based on an IP address associated with a contact's telephony device.

6. The method of claim 1, wherein the contact information is determined based on information obtained from at least one social network.

7. The method of claim 1, wherein the contact information comprises at least one of a current time of day at a contact's location, a current weather at a contact's location, and/or a roaming status associated with a contact's telephony device.

8. The method of claim 1, further comprising determining a sub-group of the contacts in the contact list that frequently communicate with the telephony device, wherein determining contact information for the one or more contacts comprises determining contact information only for the contacts in the determined sub-group.

9. The method of claim 1, further comprising transmitting the generated display information to at least one telephony device.

10. The method of claim 1, further comprising displaying the one or more contacts in the contact list based on the generated display information.

11. The method of claim 10, wherein displaying the one or more contacts comprises altering how at least one contact on the contact list would normally be displayed based on the generated display information.

12. The method of claim 10, wherein displaying the one or more contacts comprises highlighting at least one contact on the contact list in some fashion based on the generated display information.

13. The method of claim 10, wherein displaying the one or more contacts comprises displaying an icon or graphical design on or adjacent at least one contact based on the received display information.

14. A system for determining display information related to one or more contacts in a contact list, comprising:
means for determining contact information for one or more contacts in at least one contact list; and
means for generating display information related to the display of the one or more contacts based on the determined contact information.

15. A system for determining display information related to one or more contacts in a contact list, comprising:
a data acquisition unit that determines contact information for one or more contacts in at least one contact list; and
a contact display data unit that generates display information related to the display of the one or more contacts based on the determined contact information.

16. The system of claim 15, wherein the data acquisition unit determines the contact information based on information provided from one or more communication devices that are operating under the Signalling System No. 7 protocol.

17. The system of claim 16, wherein the contact information is location-based information related to a location of a contact.

18. The system of claim 15, wherein the data acquisition unit determines the contact information using a telephone number associated with the one or more contacts.

19. The system of claim 15, wherein the data acquisition unit determines the contact information for a contact based on an IP address associated with a contact's telephony device.

20. The system of claim 15, wherein the data acquisition unit determines the contact information by obtaining information from at least one social network.

21. The system of claim 15, wherein the contact information comprises at least one of a current time of day at a contact's location, a current weather at a contact's location, and/or a roaming status associated with a contact's telephony device.

22. The system of claim 15, wherein the data acquisition unit identifies a sub-group of the contacts in the contact list, and wherein the data acquisition unit determines contact information only for the contacts in the sub-group.

23. The system of claim 15, wherein the contact display data unit transmits the generated display information to at least one telephony device.

24. The system of claim 15, further comprising a display unit that displays the one or more contacts in the contact list based on the generated display information.

25. The system of claim 24, wherein the display unit alters how at least one contact on the contact list would normally be displayed based on the generated display information.

26. The system of claim 24, wherein the display unit highlights at least one contact on the contact list in some fashion based on the generated display information.

27. The system of claim 24, wherein the display unit displays an icon or graphical design on or adjacent at least one contact based on the received display information.

28. A method implemented in a telephony device and for displaying one or more contacts on a contact list, comprising:
receiving display information for one or more contacts on a contact list, the display information indicating how individual contacts should be displayed; and
displaying the one or more contacts in the contact list based on the received display information.

29. The method of claim 27, further comprising:
receiving input from a user of the telephony device, the input indicating that the user would like to obtain information about at least one contact on a contact list;
requesting contact information for the at least one contact from an element of an IP telephony system; and
receiving the requested contact information from the IP telephony system.

30. A non-transitory computer readable medium having stored thereon instructions which, when executed by one or more processors of a telephony device, cause the telephony device to perform a method for displaying one or more contacts on a contact list, the method comprising:
receiving display information for one or more contacts on a contact list, the display information indicating how individual contacts should be displayed; and
displaying the one or more contacts in the contact list based on the received display information.

31. The non-transitory computer readable medium of claim 29, wherein the instructions also cause the telephony device to perform the steps of:
receiving input from a user of the telephony device, the input indicating that the user would like to obtain information about at least one contact on a contact list;
requesting contact information for the at least one contact from an element of an IP telephony system; and
receiving the requested contact information from the IP telephony system.
